(19) United States
(12) Patent Application Publication
(10) Pub. No.: US 2024/0389114 A1
(43) Pub. Date: Nov. 21, 2024

(54) SIGNALING FOR INTER-UE-COORDINATION MESSAGE

(71) Applicant: QUALCOMM Incorporated, San Diego, CA (US)

(72) Inventors: Shuanshuan WU, San Diego, CA (US); Gabi SARKIS, San Diego, CA (US); Qing LI, Princeton Junction, NJ (US); Tien Viet NGUYEN, Bridgewater, NJ (US); Hui GUO, Beijing (CN); Sourjya DUTTA, San Diego, CA (US); Kapil GULATI, Belle Mead, NJ (US); Hong CHENG, Basking Ridge, NJ (US); Gene Wesley MARSH, San Diego, CA (US); Shailesh PATIL, San Diego, CA (US)

(21) Appl. No.: 18/690,708

(22) PCT Filed: Oct. 7, 2021
(86) PCT No.: PCT/CN2021/122524

§ 371 Date: Mar. 8, 2024

(51) Int. Cl. H04W 72/25; H04W 72/40

(52) U.S. Cl. CPC H04W 72/25; H04W 72/40

(57) ABSTRACT

Apparatus, methods, and computer-readable media for facilitating a SL communication for mode 2 resource allocation are disclosed herein. An example method includes configuring an inter-UE coordination message associated with sidelink communication with a second UE, the inter-UE coordination message indicating one or more resources for the sidelink communication. The example method further includes transmitting, to the second UE, the inter-UE coordination message via a MAC-CE, the MAC-CE being associated with a PSSCH. The example method further includes transmitting, to the second UE, or receiving, from the second UE, the sidelink communication via a first resource of the one or more resources.

### TECHNICAL FIELD

The present disclosure relates generally to communication systems, and more particularly, to wireless communication utilizing sidelink (SL) communication between a user equipment (UE) with first stage sidelink control information (SCI-1) and second stage SCI (SCI-2).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may include direct communication between devices based on sidelink. There exists a need for further improvements in sidelink technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus for wireless communication is provided. The apparatus may be a UE that includes a memory and at least one processor coupled to the memory, the memory and the at least one processor configured to configure an inter-UE coordination message associated with sidelink communication with a second UE, the inter-UE coordination message indicating one or more resources for the sidelink communication. The memory and the at least one processor may also be configured to transmit, to the second UE, the inter-UE coordination message via a medium access control (MAC) control element (CE) (MAC-CE), the MAC-CE being associated with a physical sidelink shared channel (PSSCH). The memory and the at least one processor may also be configured to transmit, to the second UE, or receive, from the second UE, the sidelink communication via a first resource of the one or more resources.

In another aspect of the disclosure, an apparatus for wireless communication is provided. The apparatus may be a UE that includes a memory and at least one processor coupled to the memory, the memory and the at least one processor configured to receive, from a first UE via a MAC-CE, an inter-UE coordination message associated with sidelink communication with the first UE, the MAC-CE being associated with a PSSCH, the inter-UE coordination message indicating one or more resources for the sidelink communication. The memory and the at least one processor may also be configured to select a first resource of the one or more resources for the sidelink communication based on the inter-UE coordination message. The memory and the at least one processor may also be configured to transmit, to the first UE, or receive, from the first UE, the sidelink communication via the selected first resource.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates example aspects of sidelink communication between devices, in accordance with aspects presented herein.

FIG. 5 illustrates examples of resource reservation for sidelink communication.

FIG. 6 is a diagram illustrating a timing diagram for a UE employing a sensing mechanism.

FIG. 7 is a diagram illustrating inter UE coordination between UEs.

FIG. 8 is a diagram illustrating communication flow between UEs.

FIG. 9 is a flowchart of a method of wireless communication at a first UE.

FIG. 10 is a flowchart of a method of wireless communication at a first UE.

FIG. 11 is a flowchart of a method of wireless communication at a first UE.

FIG. 12 is a flowchart of a method of wireless communication at a first UE.

FIG. 13 is a diagram illustrating an example of a hardware implementation for an example apparatus, in accordance with the teachings disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, end-user devices, etc. of varying sizes, shapes, and constitution.

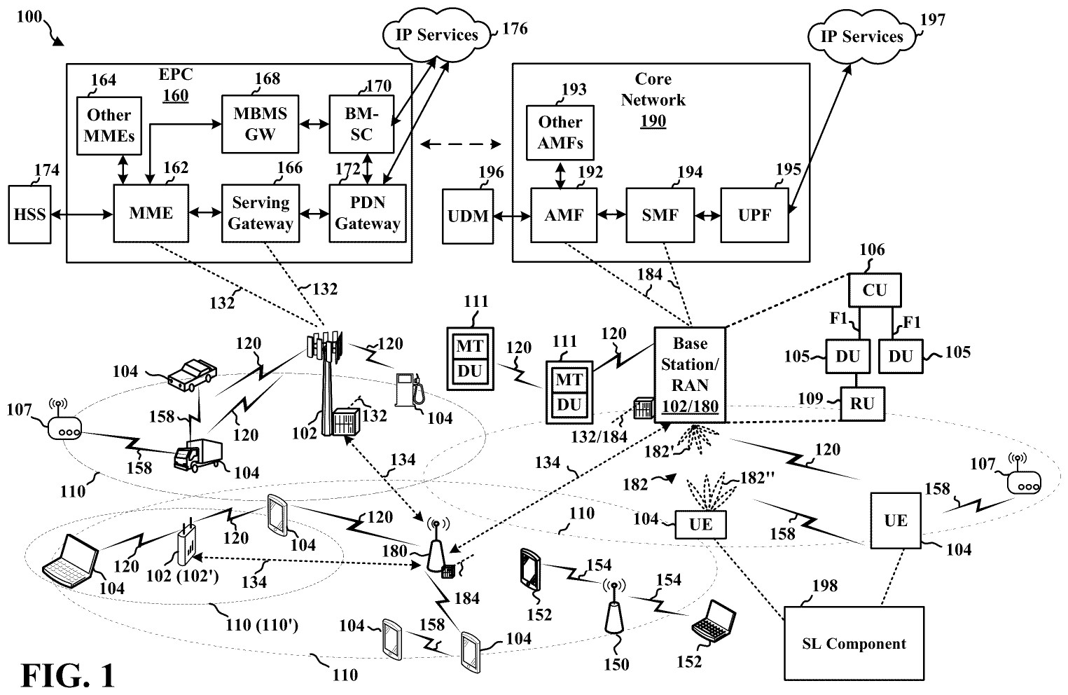

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

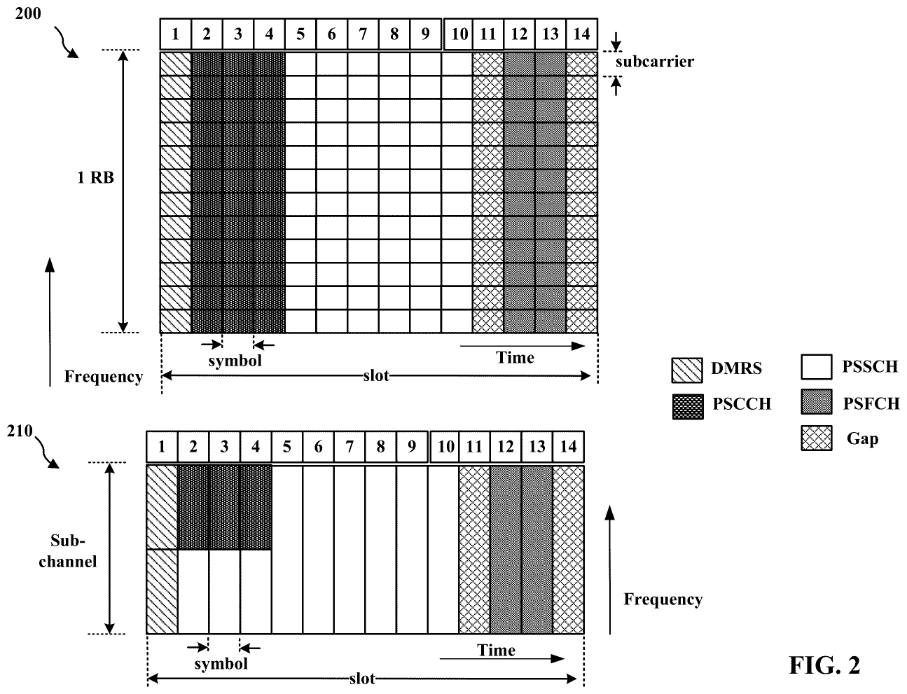

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. In some examples, an intermediary device (e.g., such as a base station 102 or 180) may facilitate communication between an originating device (e.g., a first UE) and a target device (e.g., a second UE) using sidelink communication. For example, a base station may allocate resources for sidelink communication, in some examples. In other examples, the devices may communicate without assistance from an intermediary device.

Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in some aspects, a sidelink communication device, such as the UE 104, may be configured to manage one or more aspects of wireless communication by facilitating resource reservation for UEs applying a power saving mode. As an example, in FIG. 1, the UE 104 may include a SL component 198 configured to configure an inter-UE coordination message associated with sidelink communication with a second UE, the inter-UE coordination message indicating one or more resources for the sidelink communication. The SL component 198 may also be configured to transmit, to the second UE, the inter-UE coordination message via a MAC-CE, the MAC-CE being associated with a PSSCH. The SL component 198 may also be configured to transmit, to the second UE, or receive, from the second UE, the sidelink communication via a first resource of the one or more resources. The SL component 198 may also be configured to receive, from a first UE via a MAC-CE, an inter-UE coordination message associated with sidelink communication with the first UE, the MAC-CE being associated with a PSSCH, the inter-UE coordination message indicating one or more resources for the sidelink communication. The SL component 198 may also be configured to select a first resource of the one or more resources for the sidelink communication based on the inter-UE coordination message. The SL component 198 may also be configured to transmit, to the first UE, or receiving, from the first UE, the sidelink communication via the selected first resource.

Although the following description provides examples directed to 5G NR (and, in particular, to sidelink communications via 5G NR), the concepts described herein may be applicable to other similar areas, such as LTE, LTE-A, CDMA, GSM, and/or other wireless technologies, in which wireless communication devices may perform resource reservations.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., an Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an FI interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 1 11 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or adjust capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols may be CP orthogonal frequency division multiplexing (OFDM) (CP-OFDM) symbols. The symbols may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIG. 2 provides an example of normal CP with 14 symbols per slot. Within a set of frames, there may be one or more different bandwidth parts (BWPs) that are frequency division multiplexed. Each BWP may have a particular numerology and CP (normal or extended).

Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 2. Multiple slots may be aggregated together in some aspects.

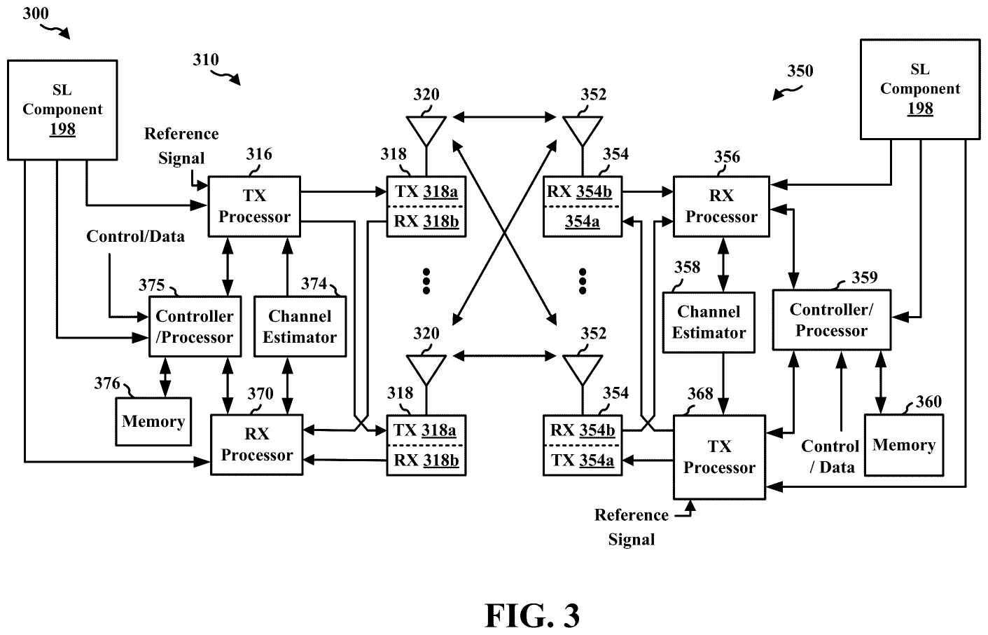

FIG. 3 is a block diagram 300 of a first wireless communication device 310 in communication with a second wireless communication device 350. The communication may be based on sidelink or an access link. In some examples, the wireless communication devices 310, 350 may communicate based on V2X or other D2D communication. In other aspects, the wireless communication devices 310, 350 may communicate over an access link based on uplink and downlink transmissions. The communication may be based on sidelink using a PC5 interface (e.g., between two UEs). The communication may be based on an access link using a Uu interface (e.g., between a base station and a UE). The wireless communication devices 310, 350 may include a UE, an RSU, a base station, etc. In some implementations, the first wireless communication device 310 may correspond to a base station and the second wireless communication device 350 may correspond to a UE.

As shown in FIG. 3, the first wireless communication device 310 includes a transmit processor (TX processor 316), a transceiver 318 including a transmitter 318a and a receiver 318b, antennas 320, a receive processor (RX processor 370), a channel estimator 374, a controller/processor 375, and memory 376. The example second wireless communication device 350 includes antennas 352, a transceiver 354 including a transmitter 354a and a receiver 354b, an RX processor 356, a channel estimator 358, a controller/processor 359, memory 360, and a TX processor 368. In other examples, the first wireless communication device 310 and/or the second wireless communication device 350 may include additional or alternative components.

Packets may be provided to the controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the second wireless communication device 350. Each spatial stream may then be provided to a different antenna 320 via a separate transmitter 318a. Each transmitter 318a may modulate a radio frequency (RF) carrier with a respective spatial stream for transmission.

At the second wireless communication device 350, each receiver 354b receives a signal through its respective antenna 352. Each receiver 354b recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the second wireless communication device 350. If multiple spatial streams are destined for the second wireless communication device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the first wireless communication device 310. These soft decisions may be based on channel estimates computed by the channel estimator 358. The soft decisions are then decoded and deinterleaved to recover the data and control signals that were originally transmitted by the first wireless communication device 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an acknowledgment (ACK) and/or negative ACK (NACK) protocol to support hybrid automatic repeat request HARQ operations.

Similar to the functionality described in connection with the transmission by the first wireless communication device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the first wireless communication device 310 may be used by the TX processor 368 to select the appropriate coding and modulation schemes, and to facilitate spatial processing. The spatial streams generated by the TX processor 368 may be provided to different antenna 352 via separate transmitters 354a. Each transmitter 354a may modulate an RF carrier with a respective spatial stream for transmission.

The transmission is processed at the first wireless communication device 310 in a manner similar to that described in connection with the receiver function at the second wireless communication device 350. Each receiver 318b receives a signal through its respective antenna 320. Each receiver 318b recovers information modulated onto an RF carrier and provides the information to the RX processor 370.

The controller/processor 375 can be associated with the memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368 or the TX processor 316, the RX processor 356 or the RX processor 370, and the controller/processor 359 or the controller/processor 375 may be configured to perform aspects in connection with the SL component 198 of FIG. 1.

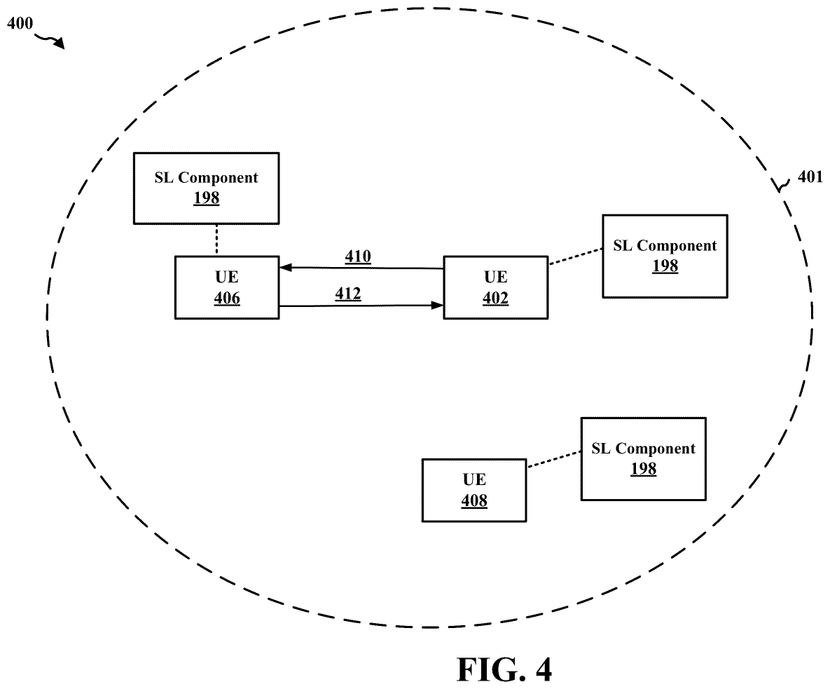

FIG. 4 illustrates an example 400 of sidelink communication between devices, as presented herein. The communication may be based on a slot structure including aspects described in connection with FIG. 2 or another sidelink structure. For example, a first UE 402 may transmit a sidelink transmission 410, e.g., including a control channel (e.g., a PSCCH) and/or a corresponding data channel (e.g., a PSSCH), that may be received by a second UE 406 and/or a third UE 408. The sidelink transmission 410 may be received directly from the first UE 402, e.g., without being transmitted through a base station.

The first UE 402, the second UE 406, and/or the third UE 408 may each be capable of operating as a transmitting device in addition to operating as a receiving device. Thus, the second UE 406 is illustrated as transmitting a sidelink transmission 412 that is received by the first UE 402. One or more of the sidelink transmissions 410, 412 may be broadcast or multicast to nearby devices. For example, the first UE 402 may transmit communications intended for receipt by other UEs within a range 401 of the first UE 402. In other examples, one or more of the sidelink transmissions 410, 412 may be groupcast to nearby devices that are a member of a group. In other examples, one or more of the sidelink transmissions 410, 412 may be unicast from one UE to another UE.

A sidelink transmission may provide sidelink control information (SCI) including information to facilitate decoding a corresponding data channel. For example, a transmitting device (sometimes referred to as an “originating device,” a “transmitting UE”, or an “originating UE”) may transmit SCI including information that a receiving device (sometimes referred to as a “target device,” a “receiving UE,” or a “target UE”) may use to avoid interference. For example, the SCI may indicate reserved time resources and/or reserved frequency resources that will be occupied by the data transmission, and may be indicated in a control message from the transmitting device. The number of TTIs, as well as the RBs that will be occupied by the data transmission, may be indicated in a control message from the first UE 402. In some examples, the SCI may be used by a receiving device to avoid interference by refraining from transmitting on the occupied resources during a data transmission.

One or more of the first UE 402, the second UE 406, and/or the third UE 408 may include an SL component, similar to the SL component 198 described in connection with FIG. 1.

Sidelink communication may be based on different types or modes of resource allocation mechanisms. In a first resource allocation mode (which may be referred to herein as “Mode 1 ”), centralized resource allocation may be provided by a network entity. For example, and referring to the example of FIG. 1, a base station 102/180 may determine resources for sidelink communication and may allocate resources to different UEs to use for sidelink transmissions. In this first mode, a UE receives the allocation of sidelink resources from the base station 102/180. In a second resource allocation mode (which may be referred to herein as “Mode 2 ”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots.

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation Mode 2, the UE may determine (e.g., sense) whether a selected sidelink resource has been reserved by other UE(s) before selecting the sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

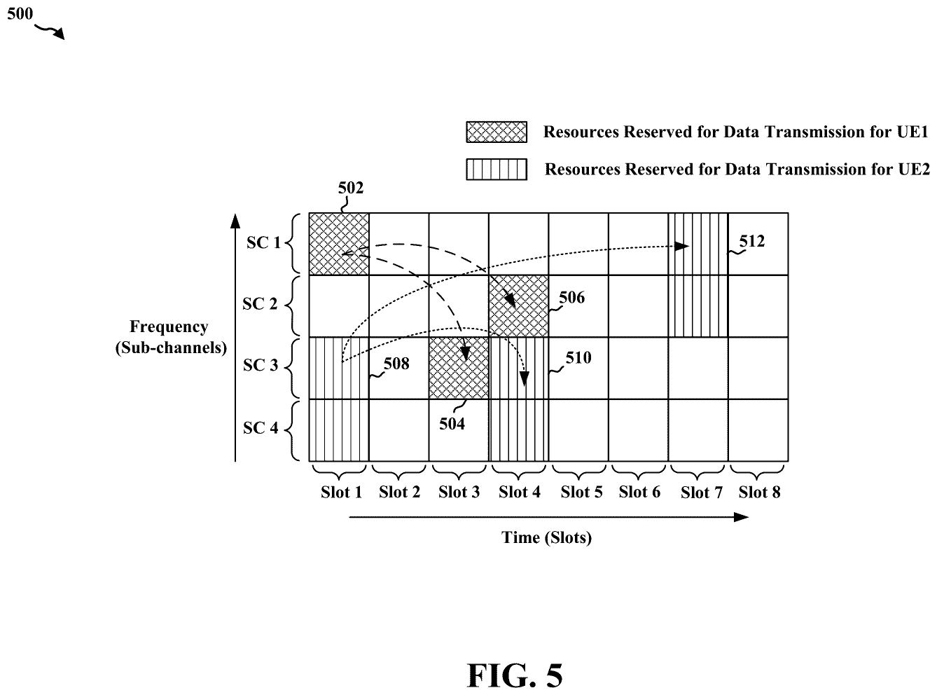

FIG. 5 is an example 500 of time and frequency resources showing reservations for sidelink transmissions, as presented herein. The resources may be included in a sidelink resource pool, for example. The resource allocation for each UE may be in units of one or more sub-channels in the frequency domain (e.g., sub-channels SC 1 to SC 4), and may be based on one slot in the time domain (e.g., slots 1 to 8). The UE may also use resources in the current slot to perform an initial transmission, and may reserve resources in future slots for retransmissions. In the illustrated example of FIG. 5, two different future slots are being reserved by UE1 and UE2 for retransmissions. The resource reservation may be limited to a window of pre-defined slots and sub-channels, such as an 8 time slots by 4 sub-channels window, as shown in example 500, which provides 32 available resource blocks in total. This window may also be referred to as a resource selection window.

A first UE (UE1) may reserve a sub-channel (e.g., SC 1) in a current slot (e.g., slot 1) for its initial data transmission 502, and may reserve additional future slots within the window for data retransmissions (e.g., a first data retransmission 504 and a second data retransmission 506). For example, the first UE may reserve sub-channels SC 3 at slot 3 and SC 2 at slot 4 for future retransmissions as shown by FIG. 5. The first UE then transmits information regarding which resources are being used and/or reserved by it to other UE(s). The first UE may do so by including the reservation information in a reservation resource field of the SCI, e.g., a first stage SCI.

FIG. 5 illustrates that a second UE (UE2) reserves resources in sub-channels SC 3 and SC 4 at slot 1 for a current data transmission 508, reserves a first data retransmission 510 at slot 4 using sub-channels SC 3 and SC 4, and reserves a second data retransmission 512 at slot 7 using sub-channels SC 1 and SC 2, as shown by FIG. 5. Similarly, the second UE may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., a packet) to be transmitted can fit.

While FIG. 5 illustrates resources being reserved for an initial transmission and two retransmissions, the reservation may be for an initial transmission and a single transmission or just for an initial transmission.

The UE may determine an associated signal measurement (such as reference signal received power (RSRP)) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, the UE may determine a set of candidate resources (e.g., by monitoring SCI from other UEs and removing resources from the set of candidate resources that are reserved by other UEs in a signal for which the UE measures an RSRP above a threshold value). The UE may also select N resources for transmissions and/or retransmissions of a transport block (TB). As an example, the UE may randomly select the N resources from the set of candidate resources previously determined. For each transmission, the UE may reserve future time and frequency resources for an initial transmission and up to two retransmissions. The UE may reserve the resources by transmitting SCI indicating the resource reservation. For example, in the example in FIG. 5, the second UE may transmit SCI reserving resources for the current data transmission 508, the first data retransmission 510, and the second data retransmission 512.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmit SCI reserving the selected resources for sidelink transmission (e.g., a PSSCH transmission) by the UE. There may be a time gap between the UE's selection of the resources and the UE transmitting SCI reserving the resources.

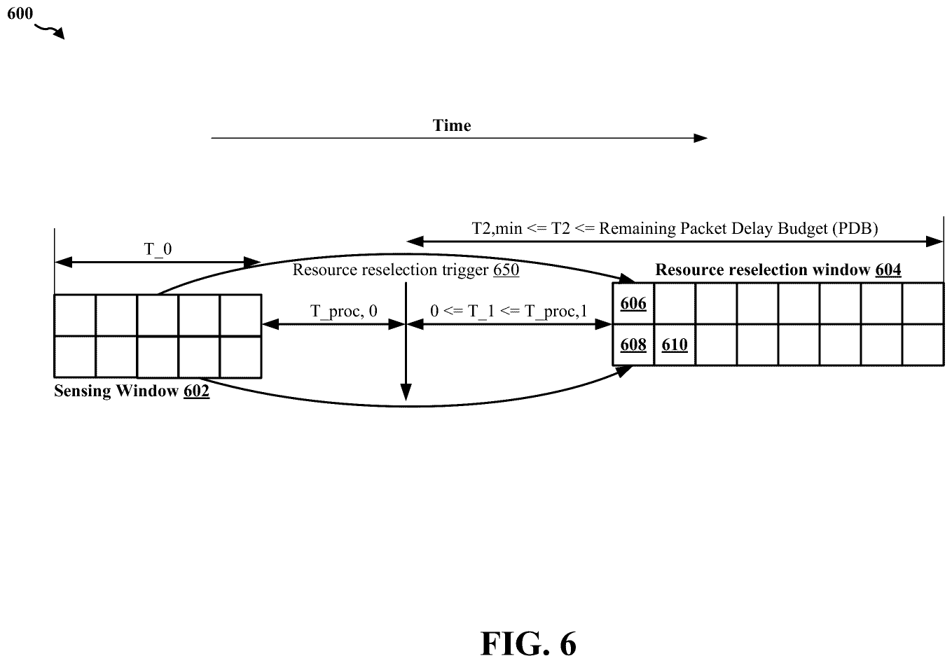

In the resource allocation Mode 2, a higher layer may request the UE 104 that includes the SL component 198 to determine a subset of resources from which the higher layer may select resources for PSSCH/PSCCH transmissions. FIG. 6 illustrates an example timing diagram 600 for a UE that may be triggered to select a resource for sidelink transmission in response to a resource selection trigger 650. The timing diagram shows a timing for sensing for resource reservations from other UEs, such as the resource reservations described in connection with FIG. 5. As an example, the resource selection trigger 650 may include having data for transmission. Although FIG. 6 is described in connection with a UE, the resource selection may also be applied by other sidelink devices. In response to the resource selection trigger 650, the UE may consider signals received within a sensing window 602 of duration T_0 and determine information (e.g., SCI with resource reservations) received within the sensing window 602. For example, the UE may determine which resources were used by other UE(s) or reserved by other UE(s) during the sensing window 602. The UE may anticipate that the previously used resources may also be used by the other UE in the future. A signal received in the sensing window may include SCI indicating a resource reservation for a resource within the resource selection window 604 following the resource selection trigger 650. Based on the past use of resources and/or the reservation of resources (e.g., the “sensing” of resources), the UE may determine which resources are scheduled for use and/or determine which resources are not scheduled for use. For example, based on the sensing of the resources during the sensing window 602, the UE may determine that a first resource 606 and a second resource 608 may be reserved during the slot associated with the resource selection trigger 650 and/or during a future slot. The UE may exclude candidate resources that are reserved by other UEs from a candidate set of resources when selecting a sidelink transmission resource. In some examples, the UE may exclude candidate resources that are reserved by another UE and that meet one or more conditions, such as the reservation signal meeting an RSRP threshold. The UE may select resource 610 for a transmission.

In some wireless communication systems, a receiving UE may perform sensing, then inform the transmitting UE (along with other UEs) about the resources that are available for transmission based on the sensing result. For example, the receiving UE may be a smartphone with a higher processing power and higher battery capacity than the transmitting UE, which may be a smartwatch with limited battery capacity and limited processing power. Therefore, it may be more efficient to have the higher processing power with higher battery capacity receiving UE to perform the sensing for the transmitting UE.

In some instances, multiple UEs may transmit at the same time and may not receive the overlapping communication (e.g., SCI indicating resource reservations) from each other and/or from a base station. Such a UE may miss or be unaware of transmissions and sidelink reservations by other UEs. Therefore, two UEs may reserve the same resource block for a future sidelink transmission, which may result in a resource collision. A resource collision occurs for sidelink transmissions that overlap at least partially in time, and which may overlap, at least partially, in frequency.

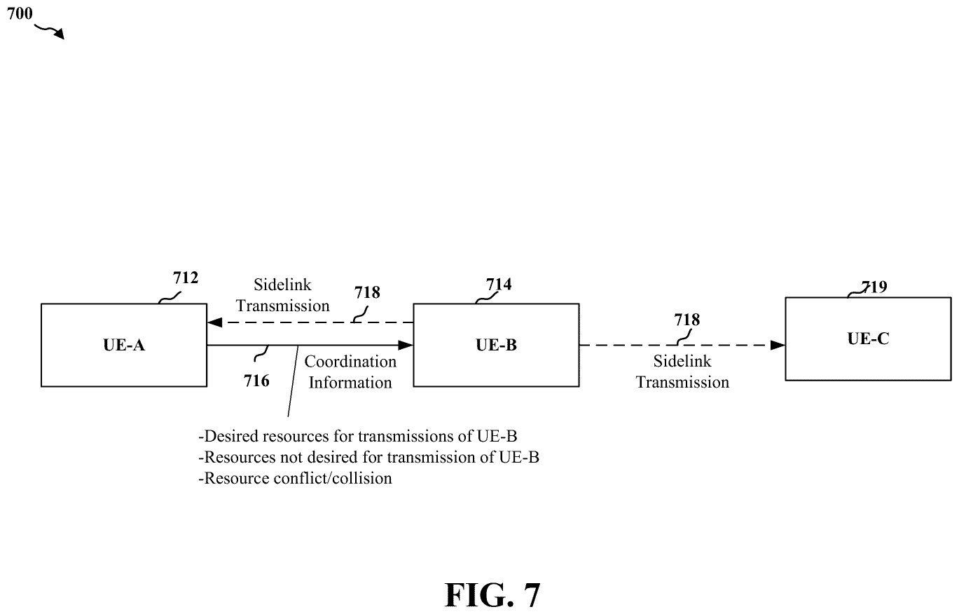

To reduce or avoid resource collisions under such instances, and to improve sidelink communication among UEs, the UEs may coordinate among themselves by generating and sharing inter-UE coordination information with other UEs. FIG. 7 is a diagram 700 illustrating the exchange of inter-UE coordination information, where a first UE (UE-A) 712 transmits inter-UE coordination information 716 to a second UE (UE-B) 714. In some aspects, the transmission of inter-UE coordination information may include resource reservation forwarding by the UE-A.

The inter-UE coordination information 716 may include information based on the UE's sensing information (e.g., resource reservations of other UEs that are sensed by UE 712 (e.g., UE-A)), inter-UE coordination information from another UE, resources that are bad, undesirable, or unfavorable (which may be otherwise referred to as “unsuitable”) for the UE-A 712 (e.g., resources subject to high interference), resources which are good, desirable, or favorable (which may be otherwise referred to as “suitable”) or better than other resources for the UE-A 712, etc.

The inter-UE coordination information 716 may indicate candidate resources for sidelink transmission or suitable resources for transmissions by UE-B 714. In some aspects, the indication of suitable resources for UE-B's transmission may be referred to as “Type A” inter-UE coordination information. The UE-A 712 may use the inter-UE coordination information 716 to inform the UE-B 714 about which sub-channels and slots may be used for communicating with the UE-A 712 and/or which sub-channels and slots may not be used because they are occupied or reserved by the UE-A 712 and/or other UEs. The UE-A may indicate a set of resources that may be more suitable for UE-B's transmission based on UE-A's evaluation. The candidate resources may indicate a group of resources from which the UE-B 714 (e.g., UE-B) may select for the sidelink transmission 718. As illustrated, the sidelink transmission 718 may be for UE-A 712 or for one or more different UEs, e.g., UE-C 719. In some aspects, the UE-A may be a potential receiver of the UE-B's transmission, and the inter-UE coordination information may enable Mode 2 resource allocation that is based on resource availability from a potential receiver's perspective, which may address reception challenges for a hidden node. In some aspects, the inter-UE coordination information 716 may indicate resources for a sidelink transmission, e.g., particular resources on which the UE-B 714 is to transmit the sidelink transmission 718 rather than candidate resources that the UE-B 714 may select.

In some aspects, the inter-UE coordination information 716 may indicate a set of resources that may not be suitable for UE-B's transmission, such as resources that may not be available for UE-B to transmit a sidelink transmission based on the UE-A's evaluation. In some aspects, the indication of unsuitable resources for UE-B's transmission may be referred to as “Type B” inter-UE coordination information.

In some aspects, the inter-UE coordination information 716 may indicate a half-duplex conflict. For example, the inter-UE coordination information 716 may indicate a collision in time and/or frequency for two transmitting UEs that are unable to receive the other, respective transmission in a half-duplex mode. In some aspects, the inter-UE coordination information 716 may indicate a collision of resources (e.g., reserved resources) in time and/or frequency. In some aspects, the indication of a collision/conflict in resources may be referred to as “Type C” inter-UE coordination information.

Based at least in part on the inter-UE coordination information 716 from the UE-A 712, the UE-B 714 may make a better decision on which resources to use and/or reserve for its sidelink transmission 718 to avoid resource collisions. The UE-A 712 may share its inter-UE coordination information 716 with multiple UEs, and the UE-B 714 may receive the inter-UE coordination information 716 from multiple UEs. Inter-UE coordination information 716 may be transmitted in any of various ways.

The UE-A 712 may transmit inter-UE coordination information 716 in a PSFCH, e.g., indicating a resource collision or a half-duplex conflict indication. The UE-A 712 may transmit inter-UE coordination information 716 in SCI. For example, the UE-A 712 may transmit shared sensing information, candidate resource information for a sidelink transmission, or particular resources for a sidelink transmission in SCI-2 transmitted in a PSSCH. For example, a first stage SCI (SCI-1) may be transmitted in a PSCCH, and a second stage of SCI (SCI-2) may be transmitted in a PSSCH. The UE-A 712 may transmit inter-UE coordination information 716 in a MAC-CE, e.g., on the PSSCH. The UE-A 712 may transmit the inter-UE coordination information 716 in a new physical channel (e.g., that is different from a PSCCH, a PSSCH, a PSFCH, etc.). For example, the UE-A 712 may transmit the inter-UE coordination information 716 in a physical channel that is configured for or dedicated to inter-UE configuration information. The UE-A 712 may transmit the inter-UE coordination information 716 in RRC signaling. The inter-UE coordination information 716 may be transmitted with the UE-B 714 as the intended recipient or may be transmitted without the UE-B 714 as the intended recipient. For example, the UE-A 712 may broadcast, unicast, or groupcast the inter-UE coordination information 716 with the UE-B 714 as the intended recipient or may be transmitted without the UE-B 714 as the intended recipient.

As one example, the SCI-2 may be mapped to contiguous RBs in a PSSCH starting from the first symbol associated with PSSCH DM-RS. A format of the SCI-2 may be indicated in the first stage SCI. The SCI-1 may be transmitted in a PSCCH. A number of resource elements (REs) may be derived based on the SCI-1. A starting location of the SCI-2 may be defined and known to a UE. In some aspects, a UE may not blindly decode SCI-2. An SCI-2 format may include one or more of a HARQ process identifier (ID), a new data indicator (NDI), a source ID, a destination ID, a CSI report trigger, or the like. An SCI-2 format associated with a groupcast may also include a zone ID indicating a location of a transmitter and a communication range for sending feedback.

In some aspects, the UE-A 712 may transmit the inter-UE coordination information 716 periodically. In some aspects, the UE-A 712 may transmit aperiodic inter-UE coordination information 716 in response to a trigger. Among other examples, the trigger may be based on the occurrence of an event, such as the occurrence/detection of a resource collision, the occurrence/detection of a half-duplex conflict, etc. For example, if the UE-A 712 detects a resource collision, the UE-A 712 may respond by transmitting inter-UE coordination information 716.

The UE-B 714 may utilize the inter-UE coordination information 716 in various ways. If the inter-UE coordination information 716 includes information about resources that are suitable for transmissions of the UE-B 714 and/or resources that are unsuitable for transmissions of the UE-B 714, the UE-B 714 may select resource(s) to be used for its sidelink transmission resource selection, or resource re-selection, may be based on both UE-B's sensing result (if available) and the received inter-UE coordination information 716 according to a first option. In a second option, the UE-B 714 may select resource(s) to be used for its sidelink transmission resource selection, or resource re-selection, which may be based on the received inter-UE coordination information 716 and not based on sensing. In a third option, the UE-B 714 may select resource(s) to be used for its sidelink transmission resource selection, or resource re-selection, which may be based on the received inter-UE coordination information 716 (which may allow the UE-B to use or not use sensing in combination with the inter-UE coordination information 716). In some aspects, the inter-UE coordination information may be piggybacked with a data packet, such as a MAC sub-protocol data unit (PDU) (SDU). In addition, the UE-B 714 may further transmit the inter-UE coordination information 716 along with additional inter-UE coordination information 716 to one or more other UEs via unicast, broadcast, or groupcast.

Inter-UE coordination information may be transmitted in an inter-UE coordination message via a MAC-CE or RRC signaling. As previously described, inter-UE coordination message may be piggybacked with data packets, such as MAC SDUs (which may be part of a TB at a physical (PHY) layer). If the UE-B 714 is not an intended recipient of one or more data packets piggybacked with the inter-UE coordination message 716, the UE-B 714 may nonetheless be an intended recipient of a MAC-CE piggybacked with the data packet carrying the inter-UE coordination message/information 716. In some wireless communication systems, if a PSSCH transmission is not addressed to the UE-B 714 (e.g., without a destination ID corresponding with UE-B 714 in SCI-2), the UE-B 714 may skip and may not be able to decode the PSSCH transmission, resulting in a potential missed MAC-CE. Aspects provided herein may provide control signaling for handling such a mismatch. In another example, the UE-A 712 may not have a data packet to piggyback with the inter-UE coordination message carrying the inter-UE coordination information 716. Aspects provided herein may provide control signaling for directly transmitting an inter-UE coordination message.

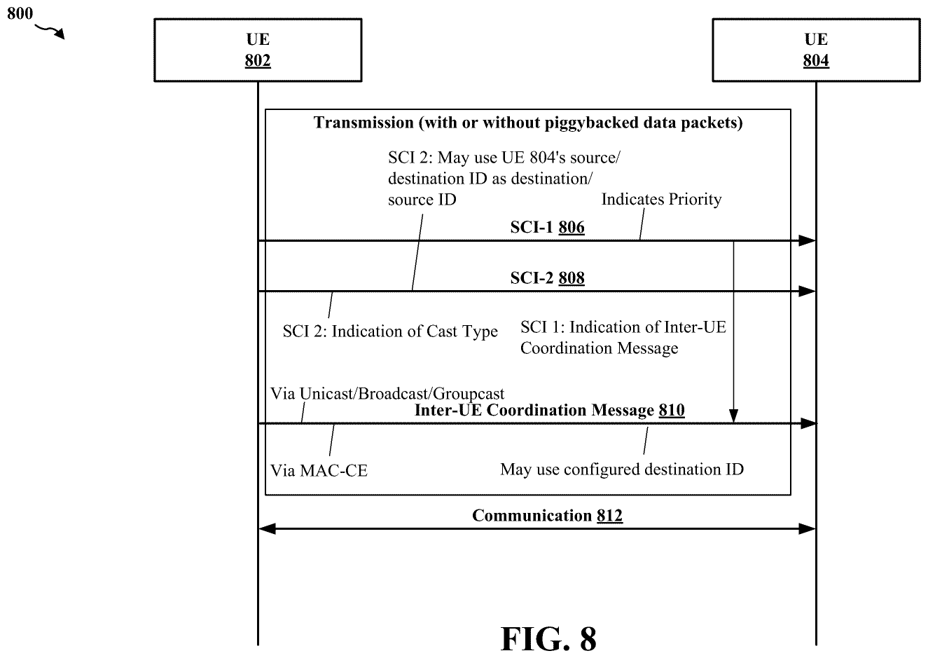

FIG. 8 is an example diagram 800 illustrating a communication flow between UEs including the transmission of inter-UE coordination information. Both the UE 802 and the UE 804 in FIG. 8 may be operating under sidelink resource allocation Mode 2. The UE 802 in FIG. 8 may correspond with the UE-A 712 in FIG. 7 and the UE 804 in FIG. 8 may correspond with the UE-B 714 in FIG. 7. The UE 802 may transmit SCI-1 806 to the UE 804. The UE 802 may further transmit an SCI-2 808 associated with the SCI-1 806. The UE 802 may further transmit inter-UE coordination message 810 which may be piggybacked with one or more data packets, such as MAC SDUs, to the UE 804. The SCI-1 806, the SCI-2 808, and the inter-UE coordination message 810 (and the one or more piggybacked data packets) may be viewed as one SL transmission. Upon receiving the transmission, the UE 804 may accordingly determine resources based on indicated suitable or non-suitable resources and exchange communication (e.g., with the UE 802 or with one or more other UEs) via unicast, broadcast, or groupcast. One or more bits in the SCI-1 806, such as one or more reserved bits in the SCI-1 806, may indicate that the UE 802's transmission carries the inter-UE coordination message 810. In some aspects, the one or more bits indicating that the transmission of the UE 802 carries the inter-UE coordination message 810 may be included regardless of whether the UE 804 is the intended recipient of the transmission or not. In such aspects, the UE 804 may decode the transmission of the UE 802 (including the SCI-2 808 and associated PSSCH) even if the UE 804 is not the intended recipient. In some aspects, MAC signaling associated with the transmission may carry one or more identifiers (IDs) associated with the UE 804. The IDs may let the UE 804 understand that the transmission is intended for the UE 804. The MAC signaling may be multiplexed with multiple destination IDs, some of which is associated with the UE 804 and some of which is not associated with the UE 804.

In some aspects, the one or more bits indicating that the transmission of the UE 802 carries the inter-UE coordination message 810 may be included if the UE 804 is the intended recipient of the transmission and may not be included if the UE 804 is not the intended recipient of the transmission. In some aspects, the SCI-2 808 may include a destination ID associated with the UE 804 and additional MAC signaling may not be included. In some aspects, the SCI-2 808 may include a destination ID associated with the UE 804 and the MAC signaling may be included. In some aspects, the transmission may be transmitted without a data packet and may include MAC-CE carrying the SCI-2 808 without additional SDUs. In some aspects, the destination ID included in the SCI-2 808 may be a source ID of the UE 804. For example, the UE 802 may be aware of the UE 804's layer-2 source ID (e.g., 24 bits), and the UE 802 may accordingly use 16 least significant bits (LSBs) or most significant bits (MSBs) of the UE 804's layer-2 source ID as the destination ID in the SCI-2 808. In another example, the UE 802 may not be aware of UE 804's layer-2 source ID and may be aware of the UE 804's layer-1 source ID (e.g., 8 bits), and the UE 802 may use the layer-1 source ID as the destination ID in the SCI-2 808. As one example, the UE 802 may map the layer-1 source ID of the UE 804 to 8 LSBs or MSBs of a 16-bit destination ID field in the SCI-2 808, and the remaining 8 MSBs or LSBs may be mapped with (pre)determined bits.

In some aspects, destination ID in the SCI-2 808 may be set to a broadcast destination ID, regardless of whether the UE 804 is the intended recipient of the transmission or not. As one example, the broadcast destination ID may be (pre)determined such that the UE 804 may be aware of the broadcast destination ID before the transmission occurred. Therefore, the UE 804 may recognize the (pre)determined broadcast destination ID and determine accordingly that inter-UE coordination message 810 included in the transmission is intended for the UE 804. In another example, the broadcast destination ID may not be known to the UE 804, and the UE 804 may decode the SCI-2 808 to determine whether inter-UE coordination message 810 included in the transmission is intended for the UE 804.

In some aspects, a source ID in the SCI-2 808 may be set to a source ID of the UE 804. As one example, the UE 804 may check a layer-1 source ID carried in the SCI-2 808 to determine whether inter-UE coordination message 810 included in the transmission is intended for the UE 804. In some aspects, the source ID in the SCI-2 808 may be set to a source ID of the UE 804 if there is no data packet piggybacked with the inter-UE coordination message 810.

In some aspects, a configured destination ID may be associated with the inter-UE coordination message 810 and may be included in the SCI-2 808. For example, the configured destination ID may be detectable for the UE 804 such that the UE 804 may proceed with PSSCH decoding upon detection of the configured destination ID in the SCI-2 808. A separate destination ID may be associated with any data packet piggybacked with the inter-UE coordination message 810.

In some aspects, the UE 802 may determine whether one or more data packets to that may be piggybacked with the inter-UE coordination message 810 is intended for the UE 804. If the one or more data packets is intended for the UE 804, the UE 802 may piggyback the inter-UE coordination message 810 with the one or more data packets. In some aspects, a separate transmission may be started if there is no data packet intended for UE 804 available. As one example, the UE 802 may generate inter-UE coordination information for the UE 804 and there may be no data packet buffered at UE 802 for the UE 804 after the inter-UE coordination information is generated and ready to be transmitted via the inter-UE coordination message 810. As another example, the UE 802 may generate inter-UE coordination information for the UE 804 and when the inter-UE coordination information is generated and ready to be transmitted via inter-UE coordination message 810, there may be one or more data packets buffered at UE 802 for the UE 804. However, piggybacking the inter-UE coordination message with the data packet may cause the transmission to not meet a delay budget for the inter-UE coordination message transmission (e.g., the data packet may be scheduled at a later time that is beyond the delay budget of the inter-UE coordination message). In some aspects, MAC signaling may be used for indicating the piggyback.

In some aspects, the SCI-2 808 may further indicate a cast type, such as unicast, broadcast, or groupcast. In some aspects, the cast type may be set to a same cast type used by the UE 804 if the inter-UE coordination message 810 is intended for the UE 804. For example, if the UE 804 may groupcast communications, such as the communication 812, the cast type may be set to groupcast. In some aspects, the cast type may be set to unicast if the inter-UE coordination message 810 is intended for the UE 804. For example, the cast type may be set to unicast if the inter-UE coordination message 810 is intended for the UE 804 and if the inter-UE coordination message is not piggybacked with data packets. In some aspects, the cast type may be set to a cast type used by the UE 802 to transmit the one or more piggybacked data packets. In some aspects, the cast type may be set to broadcast when the transmission carries the inter-UE coordination message 810.

A priority may be indicated in the SCI-1 806. For example, the priority may be of a value (pre)configured for the transmission of the inter-UE coordination message 810. In another example, the priority may be based on (e.g., identical to) a priority of the communication 812 transmitted by the UE 804. In another example, the priority may be based on (e.g., identical to) a priority of the one or more data packets piggybacked and transmitted by the UE 802 with the transmission carrying the inter-UE coordination message 810. In some aspects, a first priority value may be (pre)configured for the transmission of the inter-UE coordination message 810 or based on (e.g., identical to) a priority of the one or more transmissions from the UE 804 that have been received by the UE 802, and a second priority value that may be associated with the data packet that the inter-UE coordination message will be piggybacking with. A smaller priority value (a smaller priority value may be equivalent to a higher priority level) of the first priority value and the second priority value may be the priority indicated in the SCI-1 806 as the priority for the transmission carrying the inter-UE coordination message 810. In some aspects, the SCI-1 806 may not indicate a separate priority of the one or more data packets piggybacked and transmitted by the UE 802. In some aspects, the SCI-1 806 may indicate a separate priority of the one or more data packets piggybacked and transmitted by the UE 802.

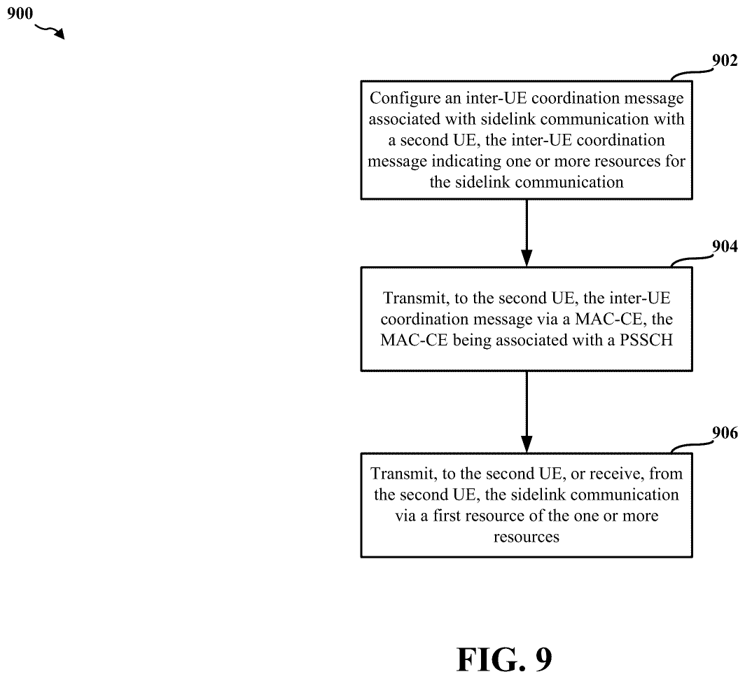

FIG. 9 is a flowchart 900 of a method of wireless communication. The method may be performed by a UE (e.g., the UE 104, the UE 802; the apparatus 1302).

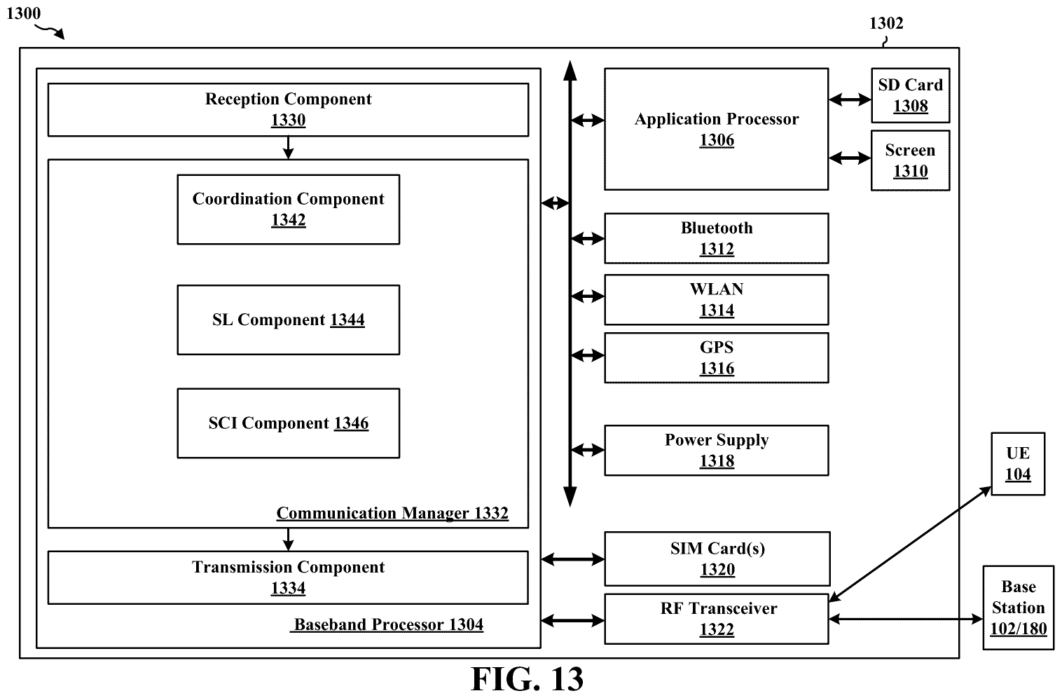

At 902, the UE may configure an inter-UE coordination message associated with sidelink communication with a second UE, the inter-UE coordination message indicating one or more resources for the sidelink communication. For example, the UE 802 may configure an inter-UE coordination message 810 associated with sidelink communication 812 with a second UE 804. The inter-UE coordination message may indicate one or more resources for the sidelink communication. In some aspects, 902 may be performed by coordination component 1342 in FIG. 13.

At 904, the UE may transmit, to the second UE, the inter-UE coordination message via a MAC-CE. The MAC-CE may be associated with a PSSCH. For example, the UE 802 may transmit, to the second UE 804, the inter-UE coordination message 810 via a MAC-CE. In some aspects, 904 may be performed by coordination component 1342 in FIG. 13.

At 906, the UE may transmit, to the second UE, or receive, from the second UE, the sidelink communication via a first resource of the one or more resources. For example, the UE 802 may transmit, to the second UE 804, or receive, from the second UE 804, the sidelink communication 812 via a first resource of the one or more resources. In some aspects, 906 may be performed by SL component 1344 in FIG. 13.

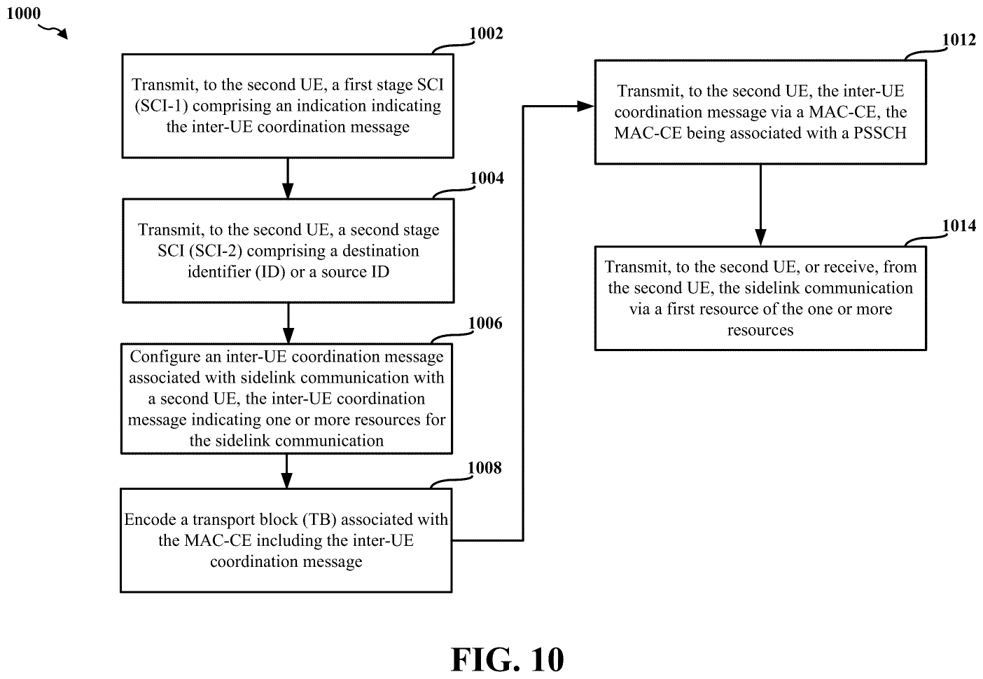

FIG. 10 is a flowchart 1000 of a method of wireless communication. The method may be performed by a UE (e.g., the UE 104, the UE 802; the apparatus 1302).

In some aspects, at 1002, the UE may transmit, to the second UE, an SCI-1 including an indication indicating the inter-UE coordination message. For example, the UE 802 may transmit, to the second UE 804, an SCI-1 806 including an indication indicating the inter-UE coordination message. In some aspects, the MAC-CE may further include an ID associated with the second UE. In some aspects, 1002 may be performed by SCI component 1346 in FIG. 13. In some aspects, the SCI-1 may indicate a priority associated with the inter-UE coordination message. For example, the SCI-1 may indicate a priority configured for the inter-UE coordination message that may be configured before the inter-UE coordination message is generated. In some aspects, the priority may correspond with a priority value associated with the communication 812 from the UE 804. In some aspects, the priority may correspond with a priority value associated with the communication 812 to the UE 804. In some aspects, the MAC-CE may be piggybacked with at least one data packet. In some aspects, the at least one data packet may be a MAC SDU. As one example, the priority may be indicated in the SCI-1 806. For example, the priority may be of a value (pre)configured for the transmission of the inter-UE coordination message 810. In another example, the priority may be based on (e.g., identical to) a priority of the communication 812 transmitted by the UE 804. In another example, the priority may be based on (e.g., identical to) a priority of the one or more data packets piggybacked and transmitted by the UE 802 with the transmission carrying the inter-UE coordination message 810. In some aspects, a first priority value may be (pre)configured for the transmission of the inter-UE coordination message 810 or based on (e.g., identical to) a priority of the one or more data packets piggybacked and transmitted by the UE 802 with the transmission carrying the inter-UE coordination message 810, and a second priority value may be based on an upper layer (higher than MAC layer and physical layer) indication. A higher priority value of the first priority value and the second priority value may be the priority indicated in the SCI-1 806. Therefore, in some aspects, the priority indicated by the SCI-1 may be different from a upper layer indication associated with one or more data packets piggybacked with the inter-UE coordination message in the MAC-CE.

In some aspects, at 1004, the UE may transmit, to the second UE, an SCI-2 including a destination ID or a source ID. For example, the UE 802 may transmit, to the second UE 804, an SCI-2 808 including a destination ID or a source ID. In some aspects, the MAC-CE may further include an ID associated with the second UE. In some aspects, 1004 may be performed by SCI component 1346 in FIG. 13. In some aspects, the destination ID may be a layer 1 source ID of the second UE or a layer 2 source ID of the second UE. In some aspects, the destination ID may be a broadcast destination ID. In some aspects, the source ID may be a layer 1 source ID of the second UE or a layer 2 source ID of the second UE. In some aspects, the destination ID may be a configured destination ID. In some aspects, the SCI-2 may include a cast type indication indicating one of unicast, broadcast, or groupcast.

At 1006, the UE may configure an inter-UE coordination message associated with sidelink communication with a second UE, the inter-UE coordination message indicating one or more resources for the sidelink communication. For example, the UE 802 may configure an inter-UE coordination message 810 associated with sidelink communication 812 with a second UE 804. The inter-UE coordination message may indicate one or more resources for the sidelink communication. In some aspects, 1006 may be performed by coordination component 1342 in FIG. 13. In some aspects, the inter-UE coordination message may be configured based on at least one traffic condition with the second UE.

In some aspects, at 1008, the UE may encode a TB associated with the MAC-CE including the inter-UE coordination message. For example, the UE 802 may encode a TB associated with the MAC-CE including the inter-UE coordination message 810. In some aspects, 1008 may be performed by coordination component 1342 in FIG. 13.

At 1012, the UE may transmit, to the second UE, the inter-UE coordination message via a MAC-CE. The MAC-CE may be associated with a PSSCH. For example, the UE 802 may transmit, to the second UE 804, the inter-UE coordination message 810 via a MAC-CE. In some aspects, 1012 may be performed by coordination component 1342 in FIG. 13.

At 1014, the UE may transmit, to the second UE, or receive, from the second UE, the sidelink communication via a first resource of the one or more resources. For example, the UE 802 may transmit, to the second UE 804, or receive, from the second UE 804, the sidelink communication 812 via a first resource of the one or more resources. In some aspects, 1014 may be performed by SL component 1344 in FIG. 13.

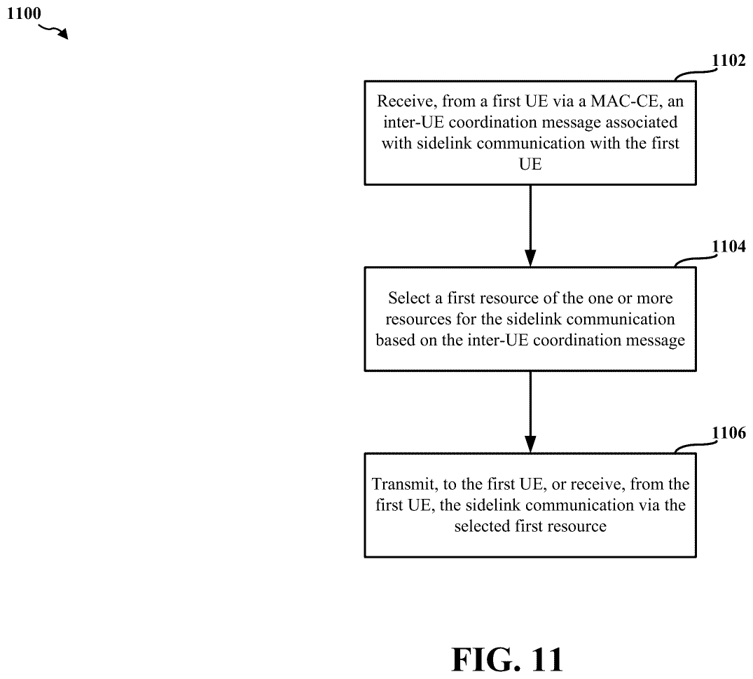

FIG. 11 is a flowchart 1100 of a method of wireless communication. The method may be performed by a UE (e.g., the UE 104, the UE 804; the apparatus 1302).

At 1102, the UE may receive, from a first UE via a MAC-CE, an inter-UE coordination message associated with sidelink communication with the first UE. The MAC-CE may be associated with a PSSCH. The inter-UE coordination message may indicate one or more resources for the sidelink communication. For example, the UE 804 may receive, from a first UE 802 via a MAC-CE, an inter-UE coordination message 810 associated with sidelink communication with the first UE. In some aspects, 1102 may be performed by coordination component 1342 in FIG. 13.

At 1104, the UE may select a first resource of the one or more resources for the sidelink communication based on the inter-UE coordination message. For example, the UE 804 may select a first resource of the one or more resources for the sidelink communication 812 based on the inter-UE coordination message 810. In some aspects, 1104 may be performed by SL component 1344 in FIG. 13.

At 1106, the UE may transmit, to the first UE, or receive, from the first UE, the sidelink communication via the selected first resource. For example, the UE 804 may transmit, to the first UE 802, or receive, from the first UE 802, the sidelink communication 812 via the selected first resource. In some aspects, 1106 may be performed by SL component 1344 in FIG. 13.

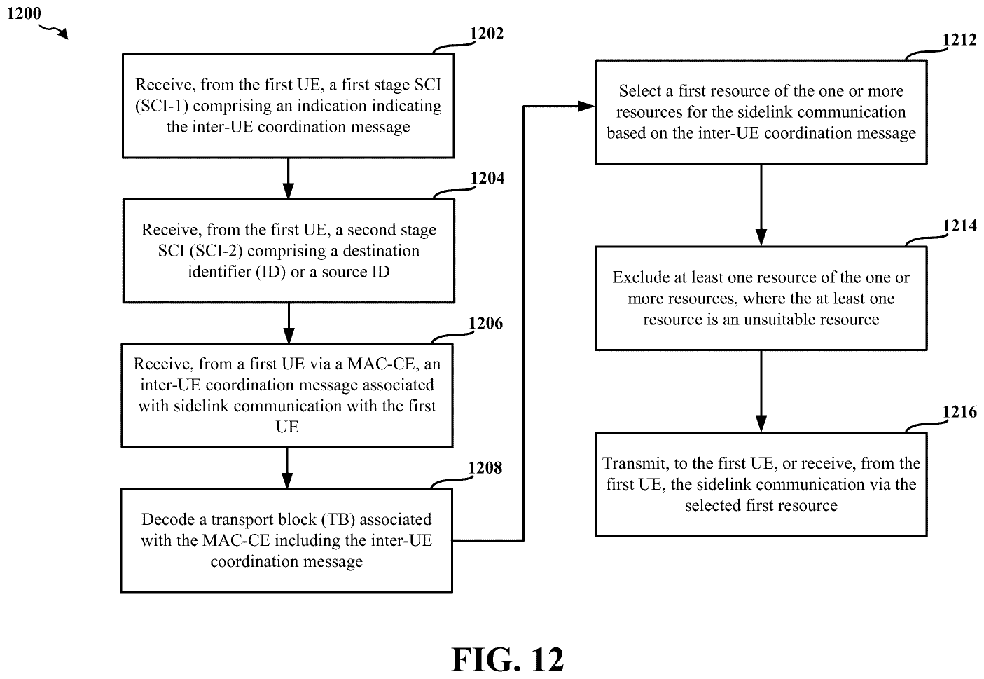

FIG. 12 is a flowchart 1200 of a method of wireless communication. The method may be performed by a UE (e.g., the UE 104, the UE 804; the apparatus 1302).

At 1202, the UE may receive, from the first UE, an SCI-1 including an indication indicating the inter-UE coordination message. For example, the UE 804 may receive, from the first UE 802, an SCI-1 806 including an indication indicating the inter-UE coordination message. In some aspects, 1202 may be performed by SCI component 1346 in FIG. 13. In some aspects, the SCI-1 may indicate a priority associated with the inter-UE coordination message. For example, the SCI-1 may indicate a priority configured for the inter-UE coordination message that may be configured before the inter-UE coordination message is generated. In some aspects, the priority may correspond with a priority value associated with the communication 812 from the UE 804. In some aspects, the priority may correspond with a priority value associated with the communication 812 to the UE 804. For example, the priority may be indicated in the SCI-1 806. For example, the priority may be of a value (pre)configured for the transmission of the inter-UE coordination message 810. In another example, the priority may be based on (e.g., identical to) a priority of the communication 812 transmitted by the UE 804. In another example, the priority may be based on (e.g., identical to) a priority of the one or more data packets piggybacked and transmitted by the UE 802 with the transmission carrying the inter-UE coordination message 810. In some aspects, a first priority value may be (pre)configured for the transmission of the inter-UE coordination message 810 or based on (e.g., identical to) a priority of the one or more data packets piggybacked and transmitted by the UE 802 with the transmission carrying the inter-UE coordination message 810, and a second priority value may be based on an upper layer (higher than MAC layer and physical layer) indication. A higher priority value of the first priority value and the second priority value may be the priority indicated in the SCI-1 806. Therefore, in some aspects, the priority indicated by the SCI-1 may be different from a upper layer indication associated with one or more data packets piggybacked with the inter-UE coordination message in the MAC-CE. In some aspects, the MAC-CE may be piggybacked with at least one data packet. In some aspects, the at least one data packet may be a MAC SDU.

At 1204, the UE may receive, from the first UE, an SCI-2 including a destination ID or a source ID. For example, the UE 804 may receive, from the first UE 802, an SCI-2 including a destination ID or a source ID. In some aspects, the MAC-CE may further include an ID associated with the second UE. In some aspects, 1204 may be performed by SCI component 1346 in FIG. 13. In some aspects, the destination ID may be a layer 1 source ID of the second UE or a layer 2 source ID of the second UE. In some aspects, the destination ID may be a broadcast destination ID. In some aspects, the source ID may be a layer 1 source ID of the second UE or a layer 2 source ID of the second UE. In some aspects, the destination ID may be a configured destination ID. In some aspects, the SCI-2 may include a cast type indication indicating one of unicast, broadcast, or groupcast.

At 1206, the UE may receive, from a first UE via a MAC-CE, an inter-UE coordination message associated with sidelink communication with the first UE. The MAC-CE may be associated with a PSSCH. The inter-UE coordination message may indicate one or more resources for the sidelink communication. For example, the UE 804 may receive, from a first UE 802 via a MAC-CE, an inter-UE coordination message 810 associated with sidelink communication with the first UE. In some aspects, 1206 may be performed by coordination component 1342 in FIG. 13.

In some aspects, at 1208, the UE may decode a TB associated with the MAC-CE including the inter-UE coordination message. For example, the UE 804 may decode a TB associated with the MAC-CE including the inter-UE coordination message. In some aspects, 1208 may be performed by coordination component 1342 in FIG. 13.

At 1212, the UE may select a first resource of the one or more resources for the sidelink communication based on the inter-UE coordination message. For example, the UE 804 may select a first resource of the one or more resources for the sidelink communication 812 based on the inter-UE coordination message 810. In some aspects, 1212 may be performed by SL component 1344 in FIG. 13.

In some aspects, the one or more resources may include at least one of a suitable resource or an unsuitable resource. At 1214, the UE may exclude at least one resource of the one or more resources. In some aspects, the at least one resource may be the unsuitable resource. For example, the UE 804 may exclude at least one resource of the one or more resources, where the at least one resource may be the unsuitable resource. In some aspects, 1214 may be performed by SL component 1344 in FIG. 13.

At 1216, the UE may transmit, to the first UE, or receive, from the first UE, the sidelink communication via the selected first resource. For example, the UE 804 may transmit, to the first UE 802, or receive, from the first UE 802, the sidelink communication 812 via the selected first resource. In some aspects, 1216 may be performed by SL component 1344 in FIG. 13.

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, or a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302.

The communication manager 1332 may include a coordination component 1342 that is configured to configure an inter-UE coordination message associated with sidelink communication with a second UE, the inter-UE coordination message indicating one or more resources for the sidelink communication, e.g., as described in connection with 902 in FIG. 9 or 1006 in FIG. 10. The coordination component 1342 may be further configured to transmit, to the second UE, the inter-UE coordination message via a MAC-CE, the MAC-CE being associated with a PSSCH, e.g., as described in connection with 904 in FIG. 9 or 1012 in FIG. 10. The coordination component 1342 may be further configured to encode a TB associated with the MAC-CE including the inter-UE coordination message, e.g., as described in connection with 1008 in FIG. 10. The coordination component 1342 may be further configured to receive, from a first UE via a MAC-CE, an inter-UE coordination message associated with sidelink communication with a second UE, e.g., as described in connection with 1102 in FIG. 11 or 1206 in FIG. 12. The coordination component 1342 may be further configured to decode a TB associated with the MAC-CE including the inter-UE coordination message, e.g., as described in connection with 1208 in FIG. 12.

The communication manager 1332 may further include an SL component 1344 that may be configured to transmit, to the second UE, or receive, from the second UE, the sidelink communication via a first resource of the one or more resources, e.g., as described in connection with 906 in FIG. 9 or 1014 in FIG. 10. The SL component 1344 may be further configured to select a first resource of the one or more resources for the sidelink communication based on the inter-UE coordination message, e.g., as described in connection with 1104 in FIG. 11 or 1212 in FIG. 12. The SL component 1344 may be further configured to exclude at least one resource of the one or more resources, where the at least one resource is an unsuitable resource, e.g., as described in connection with 1214 in FIG. 12. The SL component 1344 may be further configured to transmit, to the first UE, or receive, from the first UE, the sidelink communication via the selected first resource, e.g., as described in connection with 1106 in FIG. 11 or 1216 in FIG. 12.

The communication manager 1332 may further include an SCI component 1346 that may be configured to transmit, to the second UE, an SCI-1 including an indication indicating the inter-UE coordination message, e.g., as described in connection with 1002 in FIG. 10. The SCI component 1346 may be further configured to transmit, to the second UE, an SCI-2 including a destination ID or a source ID, e.g., as described in connection with 1004 in FIG. 10. The SCI component 1346 may be further configured to receive, from the first UE, an SCI-1 including an indication indicating the inter-UE coordination message, e.g., as described in connection with 1202 in FIG. 12. The SCI component 1346 may be further configured to receive, from the first UE, an SCI-2 including a destination ID or a source ID, e.g., as described in connection with 1204 in FIG. 12.

The apparatus may include additional components that perform each of the blocks of the algorithm in the flowcharts of FIGS. 9-12. As such, each block in the flowcharts of FIGS. 9-12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, may include means for configuring an inter-UE coordination message associated with sidelink communication with a second UE, the inter-UE coordination message indicating one or more resources for the sidelink communication. The cellular baseband processor 1304 may further include means for transmitting, to the second UE, the inter-UE coordination message via a MAC-CE, the MAC-CE being associated with a PSSCH. The cellular baseband processor 1304 may further include means for transmitting, to the second UE, or receive, from the second UE, the sidelink communication via a first resource of the one or more resources. The cellular baseband processor 1304 may further include means for encoding a TB associated with the MAC-CE including the inter-UE coordination message. The cellular baseband processor 1304 may further include means for transmitting, to the second UE, an SCI-1 including an indication indicating the inter-UE coordination message. The cellular baseband processor 1304 may further include means for transmitting, to the second UE, an SCI-2 including a destination ID or a source ID. The cellular baseband processor 1304 may further include means for receiving, from a first UE via a MAC-CE, an inter-UE coordination message associated with sidelink communication with a second UE, the MAC-CE being associated with a PSSCH, the inter-UE coordination message indicating one or more resources for the sidelink communication. The cellular baseband processor 1304 may further include means for selecting a first resource of the one or more resources for the sidelink communication based on the inter-UE coordination message. The cellular baseband processor 1304 may further include means for transmitting, to the first UE, or receiving, from the first UE, the sidelink communication via the selected first resource. The cellular baseband processor 1304 may further include means for excluding at least one resource of the one or more resources, where the at least one resource is the unsuitable resource. The cellular baseband processor 1304 may further include means for decoding a TB associated with the MAC-CE including the inter-UE coordination message. The cellular baseband processor 1304 may further include means for receiving, from the first UE, an SCI-1 including an indication indicating the inter-UE coordination message. The cellular baseband processor 1304 may further include means for receiving, from the first UE, an SCI-2 including a destination ID or a source ID. The means may be one or more of the components of the apparatus 1302 configured to perform the functions recited by the means. As described supra, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

Aspects provided herein may enhance inter-UE coordination message by utilizing various control signaling so that piggybacked inter-UE coordination message may be efficiently decoded by a receiving UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first UE, including: a memory; and at least one processor coupled to the memory and configured to: configure an inter-UE coordination message associated with sidelink communication with a second UE, the inter-UE coordination message indicating one or more resources for the sidelink communication; transmit, to the second UE, the inter-UE coordination message via a MAC-CE, the MAC-CE being associated with a PSSCH; and transmit, to the second UE, or receive, from the second UE, the sidelink communication via a first resource of the one or more resources.

Aspect 2 is the apparatus of aspect 1, wherein the inter-UE coordination message may be configured based on at least one traffic condition with the second UE.

Aspect 3 is the apparatus of any of aspects 1-2, wherein the at least one processor coupled to the memory may be further configured to: encode a TB associated with the MAC-CE including the inter-UE coordination message.

Aspect 4 is the apparatus of any of aspects 1-3, wherein the at least one processor coupled to the memory may be further configured to: transmit, to the second UE, a SCI-1 including an indication indicating the inter-UE coordination message.

Aspect 5 is the apparatus of any of aspects 1-4, wherein the MAC-CE further may include an ID associated with the second UE.

Aspect 6 is the apparatus of any of aspects 1-5, wherein the SCI-1 indicates a priority associated with the inter-UE coordination message, the priority being different from a upper layer indication associated with one or more data packets piggybacked with the inter-UE coordination message in the MAC-CE.

Aspect 7 is the apparatus of any of aspects 1-6, wherein the at least one processor coupled to the memory may be further configured to: transmit, to the second UE, a SCI-2 including a destination ID or a source ID.

Aspect 8 is the apparatus of any of aspects 1-7, wherein the destination ID may be a layer 1 source ID of the second UE or a layer 2 source ID of the second UE.

Aspect 9 is the apparatus of any of aspects 1-8, wherein the destination ID may be a broadcast destination ID.

Aspect 10 is the apparatus of any of aspects 1-9, wherein the source ID may be a layer 1 source ID of the second UE or a layer 2 source ID of the second UE.

Aspect 11 is the apparatus of any of aspects 1-10, wherein the destination ID may be a configured destination ID.

Aspect 12 is the apparatus of any of aspects 1-11, wherein the SCI-2 may include a cast type indication indicating one of a unicast, a broadcast, or a groupcast.

Aspect 13 is the apparatus of any of aspects 1-12, wherein the MAC-CE may be piggybacked with at least one data packet.

Aspect 14 is the apparatus of any of aspects 1-13, further including a transceiver coupled to the at least one processor, and wherein the at least one data packet may be a MAC SDU.

Aspect 15 is an apparatus for wireless communication at a second UE, including: a memory; and at least one processor coupled to the memory and configured to: receive, from a first UE via a MAC-CE, an inter-UE coordination message associated with sidelink communication with a second UE, the MAC-CE being associated with a PSSCH, the inter-UE coordination message indicating one or more resources for the sidelink communication; select a first resource of the one or more resources for the sidelink communication based on the inter-UE coordination message; and transmit, to the first UE, or receiving, from the first UE, the sidelink communication via the selected first resource.

Aspect 16 is the apparatus of aspect 15, wherein the one or more resources include at least one of a suitable resource or an unsuitable resource, and wherein the at least one processor coupled to the memory may be further configured to: exclude at least one resource of the one or more resources, wherein the at least one resource may be the unsuitable resource.

Aspect 17 is the apparatus of any of aspects 15-16, wherein the at least one processor coupled to the memory may be further configured to: decode a TB associated with the MAC-CE including the inter-UE coordination message.

Aspect 18 is the apparatus of any of aspects 15-17, wherein the at least one processor coupled to the memory may be further configured to: receive, from the first UE, a SCI-1 including an indication indicating the inter-UE coordination message.

Aspect 19 is the apparatus of any of aspects 15-18, wherein the SCI-1 indicates a priority associated with the inter-UE coordination message, the priority being different from a upper layer indication associated with one or more data packets piggybacked with the inter-UE coordination message in the MAC-CE.

Aspect 20 is the apparatus of any of aspects 15-19, wherein the MAC-CE further may include an ID associated with the second UE.

Aspect 21 is the apparatus of any of aspects 15-20, wherein the at least one processor coupled to the memory may be further configured to: receive, from the first UE, a SCI-2 including a destination ID or a source ID.

Aspect 22 is the apparatus of any of aspects 15-21, wherein the destination ID may be a layer 1 source ID of the second UE or a layer 2 source ID of the second UE.

Aspect 23 is the apparatus of any of aspects 15-22, wherein the destination ID may be a broadcast destination ID.

Aspect 24 is the apparatus of any of aspects 15-23, wherein the source ID may be a layer 1 source ID of the second UE or a layer 2 source ID of the second UE.

Aspect 25 is the apparatus of any of aspects 15-24, wherein the destination ID may be a configured destination ID.

Aspect 26 is the apparatus of any of aspects 15-25, wherein the SCI-2 may include a cast type indication indicating one of a unicast, a broadcast, or a groupcast.

Aspect 27 is the apparatus of any of aspects 15-26, wherein the MAC-CE may be piggybacked with at least one data packet.

Aspect 28 is the apparatus of any of aspects 15-27, further including a transceiver coupled to the at least one processor, and wherein the at least one data packet may be a MAC SDU.

Aspect 29 is a method of wireless communication for implementing any of aspects 1to 14.

Aspect 30 is an apparatus for wireless communication including means for implementing any of aspects 1 to 14.

Aspect 31 is a computer-readable medium storing computer executable code, where the code when executed by a processor causes the processor to implement any of aspects 1 to 14.

Aspect 32 is a method of wireless communication for implementing any of aspects 15to 28.

Aspect 33 is an apparatus for wireless communication including means for implementing any of aspects 15 to 28.

Aspect 34 is a computer-readable medium storing computer executable code, where the code when executed by a processor causes the processor to implement any of aspects 15 to 28.

1. An apparatus for wireless communication at a first user equipment (UE), comprising:
memory; and
at least one processor coupled to the memory and configured to:
configure an inter-UE coordination message associated with sidelink communication with a second UE, the inter-UE coordination message indicating one or more resources for the sidelink communication;
transmit, to the second UE, the inter-UE coordination message via a medium access control (MAC) control element (CE) (MAC-CE), the MAC-CE being associated with a physical sidelink shared channel (PSSCH); and
transmit, to the second UE, or receive, from the second UE, the sidelink communication via a first resource of the one or more resources.

2. The apparatus of claim 1, wherein the inter-UE coordination message is configured based on at least one traffic condition with the second UE.

3. The apparatus of claim 1, wherein the at least one processor coupled to the memory is further configured to:
encode a transport block (TB) associated with the MAC-CE including the inter-UE coordination message.

4. The apparatus of claim 1, wherein the at least one processor coupled to the memory is further configured to:
transmit, to the second UE, first stage sidelink control information (SCI) (SCI-1) comprising an indication of the inter-UE coordination message.

5. The apparatus of claim 4, wherein the MAC-CE further comprises an identifier (ID) associated with the second UE.

6. The apparatus of claim 5, wherein the SCI-1 indicates a priority associated with the inter-UE coordination message, the priority being different from a upper layer indication associated with one or more data packets piggybacked with the inter-UE coordination message in the MAC-CE.

7. The apparatus of claim 1, wherein the at least one processor coupled to the memory is further configured to:
transmit, to the second UE, second stage sidelink control information (SCI) (SCI-2) comprising a destination identifier (ID) or a source ID.

8. The apparatus of claim 7, wherein the destination ID is a layer 1 source ID of the second UE or a layer 2 source ID of the second UE.

9. The apparatus of claim 7, wherein the destination ID is a broadcast destination ID.

10. The apparatus of claim 7, wherein the source ID is a layer 1 source ID of the second UE or a layer 2 source ID of the second UE.

11. The apparatus of claim 7, wherein the destination ID is a configured destination ID.

12. The apparatus of claim 7, wherein the SCI-2 comprises a cast type indication indicating one of unicast, broadcast, or groupcast.

13. The apparatus of claim 1, wherein the MAC-CE is piggybacked with at least one data packet.

14. The apparatus of claim 13, further comprising a transceiver coupled to the at least one processor, and wherein the at least one data packet is a MAC sub-protocol data unit (SDU).

15. An apparatus for wireless communication at a second user equipment (UE), comprising:
memory; and
at least one processor coupled to the memory and configured to:
receive, from a first UE via a medium access control (MAC) control element (CE) (MAC-CE), an inter-UE coordination message associated with sidelink communication with the first UE, the MAC-CE being associated with a physical sidelink shared channel (PSSCH), the inter-UE coordination message indicating one or more resources for the sidelink communication;
select a first resource of the one or more resources for the sidelink communication based on the inter-UE coordination message; and
transmit, to the first UE, or receive, from the first UE, the sidelink communication via the selected first resource.

16. The apparatus of claim 15, wherein the one or more resources include at least one of a suitable resource or an unsuitable resource, and wherein the at least one processor coupled to the memory is further configured to:
exclude at least one resource of the one or more resources, wherein the at least one resource is the unsuitable resource.

17. The apparatus of claim 15, wherein the at least one processor coupled to the memory is further configured to:
decode a transport block (TB) associated with the MAC-CE including the inter-UE coordination message.

18. The apparatus of claim 15, wherein the at least one processor coupled to the memory is further configured to:
receive, from the first UE, first stage sidelink control information (SCI) (SCI-1) comprising an indication of the inter-UE coordination message.

19. The apparatus of claim 18, wherein the SCI-1 indicates a priority associated with the inter-UE coordination message, the priority being different from a upper layer indication associated with one or more data packets piggybacked with the inter-UE coordination message in the MAC-CE.

20-28. (canceled)

29. A method of wireless communication at a first user equipment (UE), comprising:
configuring an inter-UE coordination message associated with sidelink communication with a second UE, the inter-UE coordination message indicating one or more resources for the sidelink communication;
transmitting, to the second UE, the inter-UE coordination message via a medium access control (MAC) control element (CE) (MAC-CE), the MAC-CE being associated with a physical sidelink shared channel (PSSCH); and
transmitting, to the second UE, or receiving, from the second UE, the sidelink communication via a first resource of the one or more resources.

30. (canceled)
